(19) United States
(12) Patent Application Publication
(10) Pub. No.: US 2008/0243412 A1
(43) Pub. Date: Oct. 2, 2008

(54) Apparatus for Inspecting Defect and Method of Inspecting Defect

(75) Inventors: Masahiro Horie, Kyoto (JP); Yoshiharu Itano, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/076,886

(22) Filed: Mar. 25, 2008

(30) Foreign Application Priority Data
Mar. 29, 2007 (JP) P2007-88409

(51) Int. Cl. G06F 19/00

(52) U.S. Cl. 702/82

(57) ABSTRACT

In a defect inspection apparatus, a first lighting part applies polarized light to an inspection region on a substrate, reflected light reflected on the inspection region is received by a first spectrometer in a first light receiving part, and a phase difference spectrum representing a reflection property of the reflected light is transmitted to an inspection part of a control part. In the control part, an inspection wavelength and a threshold value determined based on theoretical calculation according to a type of defects to be detected are stored in a memory in advance, and a group of defects in a plurality of recessed portions formed in the inspection region are detected based on the threshold value and a phase difference in an inspection wavelength obtained from the phase difference spectrum. Thus, it is possible to detect a defect in a small recessed portion on the substrate with high accuracy.

### BACKGROUND OF THE INVENTION

1. Field of the Invention

The present invention relates to a technique for inspecting defects by applying light to a semiconductor substrate.

2. Description of the Background Art

As a non destructive defect inspection method of a semiconductor substrate (hereinafter, simply referred to as “substrate”), a bright-field or dark-field optical inspection method and a SEM (Scanning Electron Microscope) inspection method have been conventionally known.

An ellipsometer is used as an optical inspection apparatus for inspecting a surface state of a film formed on the substrate or measuring a thickness of the film. The ellipsometer emits polarized light onto the substrate to acquire a polarization state of the light reflected on the substrate and performs ellipsometry to thereby inspect a surface state of the substrate. For example, Japanese Patent Application Laid-Open No. 2005-3666 discloses a spectroscopic ellipsometer for performing various inspections on a single layer film or a multilayer film on the basis of the polarization state at each wavelength of the reflected light.

In recent, required is defect inspection in a recessed portion with a trench structure, a hole structure or the like, the recessed portion being formed on the substrate and having a high aspect ratio (i.e., a small opening width and a deep depth). In a conventional inspection apparatus using the optical inspection method or the SEM inspection method, it is possible to inspect the surface of the substrate, but it is difficult to accurately detect a defect which exists only in the recessed portion formed on the substrate.

In the meantime, a technique for obtaining a shape of the recessed portion on the substrate by scatterometory where a property of reflected light in changing a pattern shape of a device is obtained by numerical analysis and a shape of a fine object is obtained by comparing the property with an actual measurement value, is now being developed, however, there are many problems in the technique, e.g., input of structural data of a pattern formed on the substrate is required, very high performance in calculation is required in an apparatus, or the like. Therefore, it is difficult to use the technique in the actual manufacturing line of a semiconductor.

### SUMMARY OF THE INVENTION

The present invention is intended for a defect inspection apparatus for inspecting defects by applying light to a semiconductor substrate. It is an object of the present invention to detect defects in recessed portions on the semiconductor substrate with high accuracy.

The defect inspection apparatus according to the present invention comprises: a memory for storing an inspection wavelength which is a wavelength of light used for inspection and a threshold value for determining the presence or absence of defects, the inspection wavelength and the threshold value being determined on the basis of theoretical calculation in accordance with a type of defects which are to be detected; a substrate holding part for holding a semiconductor substrate; a lighting part for directing light emitted from a light source to an inspection region on a main surface of the semiconductor substrate; a light receiving part having a sensor for receiving reflected light reflected on the inspection region on the semiconductor substrate to acquire a reflection property of the reflected light in at least the inspection wavelength; and an inspection part for detecting a group of defects in a plurality of recessed portions which are formed in the inspection region on the semiconductor substrate, on the basis of the reflection property outputted from the sensor and the threshold value stored in the memory. According to the present invention, it is possible to detect defects in recessed portions on the semiconductor substrate with high accuracy.

According to a preferred embodiment of the present invention, the light emitted from the light source enters the main surface of the semiconductor substrate through an objective lens so as to be perpendicular to the main surface, and the reflection property outputted from the sensor is a ratio of intensity of the reflected light relative to intensity of the light which enters the semiconductor substrate from the lighting part. Preferably, the defect inspection apparatus further comprises: an objective lens exchanging mechanism for exchanging the objective lens to another objective lens whose magnification is greater than that of the objective lens; and another inspection part for detecting a defect on a small inspection region included in the inspection region on the basis of a bright-field image of the small inspection region, the bright-field image being acquired by the sensor which is an image pickup element through another objective lens while the light emitted from the light source is applied to the semiconductor substrate.

According to another preferred embodiment of the present invention, the light emitted from the light source is polarized and polarized light enters the main surface of the semiconductor substrate from the lighting part so as to incline to the main surface, and the reflection property which is outputted from the sensor is a polarization state of the reflected light. Preferably, the memory stores an inspection reflection angle which is a reflection angle on the semiconductor substrate of light used for inspection, the reflection angle being determined on the basis of theoretical calculation in accordance with a type of defects which are to be detected, and the lighting part or the light receiving part comprises a reflection angle changing part for changing a reflection angle on the semiconductor substrate of the reflected light which is received by the sensor to the inspection reflection angle. More preferably, the defect inspection apparatus further comprises: an image pickup element for receiving scattered light scattered on a small inspection region included in the inspection region to acquire a dark-field image of the small inspection region while the light emitted from the light source is applied to the semiconductor substrate; and another inspection part for detecting a defect on the small inspection region on the basis of the dark-field image.

According to still another preferred embodiment of the present invention, the lighting part or the light receiving part comprises a wavelength changing part for changing a wavelength of the reflected light which is received by the sensor to the inspection wavelength. Preferably, the wavelength changing part is an optical filter which is positioned on an optical path from the light source emitting white light to the sensor, and the optical filter limits the wavelength of the reflected light to the inspection wavelength. More preferably, the memory stores a plurality of inspection wavelengths and a plurality of threshold values both of which correspond to a plurality of types of defects, respectively, the lighting part or the light receiving part further comprises: a plurality of optical filters each of which transmits light with one of the plurality of inspection wavelengths; and a filter exchanging mechanism for exchanging an optical filter which is positioned on the optical path out of the plurality of optical filters to another optical filter, and the inspection part inspects the presence or absence of each group of the plurality of types of defects on the basis of the plurality of threshold values and a plurality of reflection properties which are outputted from the sensor correspondingly to the plurality of inspection wavelengths, respectively.

According to still another preferred embodiment of the present invention, the light source emits white light, and the sensor is a spectrometer for acquiring a reflection property at each wavelength of the reflected light. Preferably, the memory stores a plurality of inspection wavelengths and a plurality of threshold values both of which correspond to a plurality of types of defects, respectively, and the inspection part inspects the presence or absence of each group of the plurality of types of defects on the basis of reflection properties at respective wavelengths of the reflected light, the plurality of inspection wavelengths, and the plurality of threshold values.

The present invention is also intended for a defect inspection method of inspecting defects by applying light to a semiconductor substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a defect inspection apparatus in accordance with the first preferred embodiment;

FIGS. 2A to 2C are enlarged cross-sectional views each showing a part of a substrate;

FIG. 3 is a view showing a first wavelength changing part;

FIG. 4 is a block diagram showing functions of a control part;

FIG. 5A is an enlarged cross-sectional view showing a part of the substrate;

FIG. 5B is a graph showing phase differences of reflected light;

FIG. 5C is a graph showing reflectance ratios of reflected light;

FIGS. 6 and 7 are flowcharts each showing a flow of defect inspection;

FIG. 8A is an enlarged cross-sectional view showing a part of the substrate;

FIG. 8B is a graph showing phase differences of reflected light;

FIG. 8C is a graph showing reflectance ratios of reflected light;

FIG. 9 is a view showing a construction of a defect inspection apparatus in accordance with the second preferred embodiment;

FIG. 10 is a block diagram showing functions of a control part; and

FIG. 11 is a view showing another example of the defect inspection apparatus.

### DESCRIPTION OF THE PREFERRED EMBODIMENTS

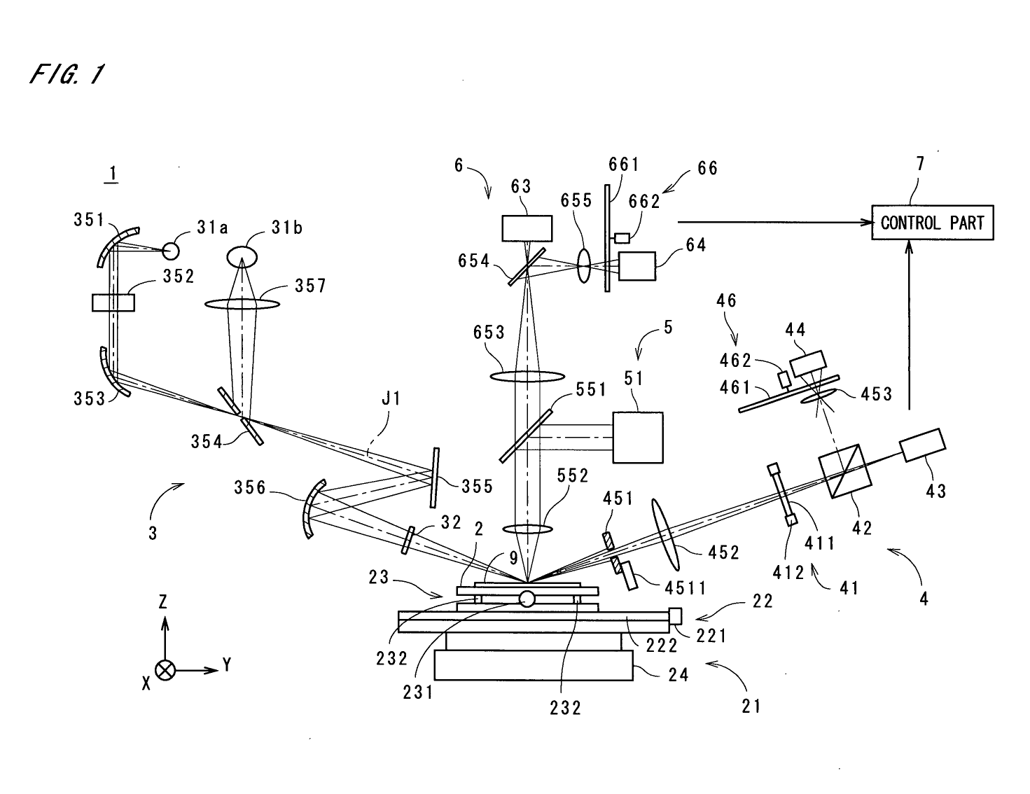

FIG. 1 is a view showing a construction of a defect inspection apparatus 1 in accordance with the first preferred embodiment of the present invention. The defect inspection apparatus 1 is an apparatus for inspecting defects in recessed portions formed on a main surface of a semiconductor substrate by applying light to the semiconductor substrate.

As shown in FIG. 1, the defect inspection apparatus 1 has a stage 2 which is a substrate holding part for holding a semiconductor substrate 9 (hereinafter, simply referred to as “substrate 9”), a stage moving mechanism 21 for moving the stage 2 in the X direction and the Y direction of FIG. 1, a first lighting part 3 and a second lighting part 5 each of which directs light to an inspection region on a main surface on the (+Z) side of the substrate 9 (the main surface is hereinafter referred to as an “upper surface”), a first light receiving part 4 and a second light receiving part 6 each of which receives reflected light reflected on the inspection region, and a control part 7 which is constituted of a CPU for performing various computations, a memory for storing various pieces of information and the like and controls the above constituent elements.

The stage moving mechanism 21 has a Y-direction moving mechanism 22 for moving the stage 2 in the Y direction of FIG. 1, an X-direction moving mechanism 23 for moving the stage 2 in the X direction, and a stage elevating mechanism 24 for moving the stage 2 in the Z direction to perform focusing. The Y-direction moving mechanism 22 has a motor 221 and a ball screw (not shown) connected with the motor 221, and with rotation of the motor 221, the X-direction moving mechanism 23 moves in the Y direction of FIG. 1 along guide rails 222. The X-direction moving mechanism 23 has the same constitution as the Y-direction moving mechanism 22, and with rotation of a motor 231, the stage 2 is moved by a ball screw (not shown) in the X direction along guide rails 232.

The first lighting part 3 has two first light sources 31a, 31b each of which is a high-intensity xenon (Xe) lamp for emitting white light and a sheet-like (or a thin-plate) polarizer 32. The light emitted from the first light source 31a or 31b is polarized by the polarizer 32 and the polarized light enters the upper surface of the substrate 9 from the first lighting part 3 so as to incline to the upper surface (at an incident angle of 70 degrees in the present preferred embodiment). A part of an optical path from the first light source 31b to a later-discussed first image pickup element 44 is not shown in FIG. 1.

The first light receiving part 4 has a rotating phase shifter 41 and an analyzer 42 in each of which reflected light of the polarized light enters and a first spectrometer 43 and the first image pickup element 44 each of which is a sensor for receiving the reflected light through the rotating phase shifter 41 and the analyzer 42 to acquire a reflection property of the reflected light. In the first light receiving part 4, each of the first spectrometer 43 and the first image pickup element 44 acquires a polarization state of the reflected light as the reflection property of the reflected light and outputs the polarization state to the control part 7.

The second lighting part 5 has a second light source 51 for emitting white light and the light emitted from the second light source 51 enters the upper surface of the substrate 9 through an objective lens 552 so as to be perpendicular to the upper surface. The second light receiving part 6 has a second spectrometer 63 and a second image pickup element 64 each of which is a sensor for receiving reflected light reflected on the substrate 9 to acquire a reflection property of the reflected light. In the second light receiving part 6, each of the second spectrometer 63 and the second image pickup element 64 acquires a ratio of intensity of the reflected light relative to intensity of the light which enters the substrate 9 from the second lighting part 5, as the reflection property of the reflected light, and outputs the ratio (i.e., reflectance) to the control part 7.

In the control part 7, a group of defects in a plurality of recessed portions which are formed in the inspection region on the substrate 9 are detected on the basis of the reflection property outputted from the first light receiving part 4 and/or the reflection property outputted from the second light receiving part 6. In the defect inspection apparatus 1, the control part 7 detects abnormality in depth or width of recessed portions as a type of the group of defects.

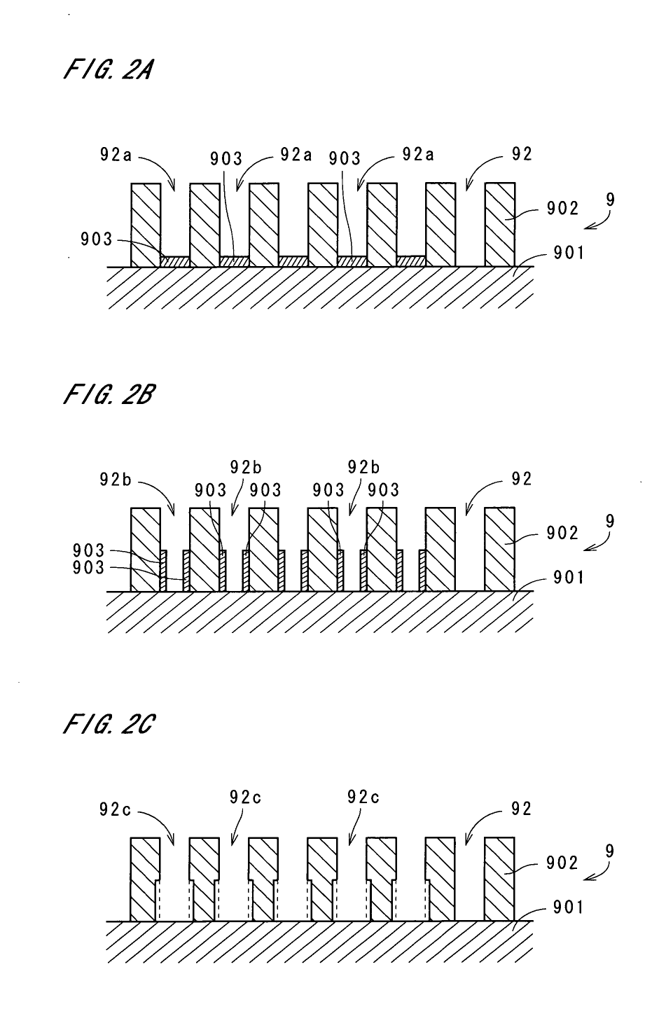

FIGS. 2A to 2C are views for explaining types of defects which are detected by the control part 7 and they are enlarged cross-sectional views each showing a part of the vicinity of the upper surface of the substrate 9. As shown in FIGS. 2A to 2C, the substrate 9 has a substrate main body 901 which is formed of silicon (Si) and a thin film 902 formed on the substrate main body 901, such as an oxide film or a resist film, and a plurality of recessed portions are formed in the film 902. FIGS. 2A to 2C show recessed portions 92a, 92b, 92c which have different types of defects and also show a normal recessed portion 92 in which no defect exists, for comparison.

FIG. 2A shows the recessed portions 92a in each of which impurities remain (so-called watermarks are formed) on the bottom part as a residue 903 after removal of processing liquid or the like applied onto the substrate 9, thereby causing abnormality of depth. FIG. 2B shows the recessed portions 92b in each of which photoresist remains (so-called footing is formed), by etching failures, on side walls in the vicinity of the bottom part as residues 903, thereby causing abnormality of width. FIG. 2C shows the recessed portions 92c in each of which side wall portions are excessively etched in the vicinity of the bottom part, thereby causing abnormality of width. In all the abnormalities shown in FIGS. 2A to 2C, abnormality does not appear at a position of an opening of a recessed portion.

Next, discussion will be made on details of the first lighting part 3 and the first light receiving part 4 and the second lighting part 5 and the second light receiving part 6. In the first lighting part 3, the light emitted from the first light source 31a is directed to a rear surface of a plate-like pinhole mirror 354 through an aspherical mirror (hereinafter, referred to as “ellipsoidal mirror”) 351 whose reflective surface is a part of a rotationally symmetric ellipsoidal surface (spheroidal surface), an infrared cut filter 352, and an ellipsoidal mirror 353.

The pinhole mirror 354 is fixed obliquely with the normal line of its reflective surface being orthogonal to the X axis and inclined to an optical axis J1 of the light from the first light source 31a by 70 degrees. The light from the first light source 31a is directed to a plane mirror 355, gradually expanding at an numerical aperture (NA) of 0.02 through an aperture part of the pinhole mirror 354 (specifically, an aperture part of square shape with sides of 150 μm (micrometer), two of which are parallel to the X axis and other two of which are orthogonal thereto). In this case, luminous flux section perpendicular to the optical axis J1 of light immediately after being emitted from the pinhole mirror 354 has a rectangular shape with long sides of 150 μm parallel to the X axis and short sides of 50 μm orthogonal thereto.

The light emitted from the pinhole mirror 354 is reflected on the plane mirror 355 and further directed to the ellipsoidal mirror 356, and light reflected on the ellipsoidal mirror 356 is directed to the polarizer 32 while being collected at a numerical aperture of 0.1. Then, polarized light which is led out by the polarizer 32 is applied to an inspection region on the substrate 9 at an incident angle of 70 degrees.

In the first lighting part 3, since the optical system from the pinhole mirror 354 to the substrate 9 is a minification optical system at a ratio of 5:1, the luminous flux section perpendicular to the optical axis J1 of the polarized light near a surface of the substrate 9 has a rectangular shape with long sides of 30 μm parallel to the X axis and short sides of 10 μm orthogonal thereto. Therefore, an irradiation region of the polarized light on the substrate 9 is a region of square with sides of about 30 μm×30 μm. A large number of recessed portions shown in FIGS. 2A to 2C are included in the irradiation region on the substrate 9.

As shown in FIG. 1, the reflected light reflected on the substrate 9 is drawn into a slit plate 451 of the first light receiving part 4 and led out to the rotating phase shifter 41. An aperture part of the slit plate 451 has a rectangular shape with sufficiently long sides parallel to the X axis and short sides orthogonal thereto and its numerical aperture with respect to a direction perpendicular to the X axis (a direction which almost corresponds to height) is 0.05. This limits a range of reflection angle on the substrate 9 of the reflected light drawn into the slit plate 451. On the other hand, since most of the reflected light is not limited in the X direction, a sufficient amount of light for measurement is let to the rotating phase shifter 41.

A slit plate moving mechanism 4511 for moving the slit plate 451 in an almost up and down direction of FIG. 1 which is perpendicular to the optical axis J1 is provided in the first light receiving part 4. The slit plate 451 is moved by the slit plate moving mechanism 4511 and thereby, an acceptance angle of the reflected light is changed by the slit plate 451. With this operation, a reflection angle on the substrate 9 of the reflected light received by the first spectrometer 43 is changed. That is to say, the slit plate 451 and the slit moving mechanism 4511 serve as a reflection angle changing part for changing a reflection angle of the reflected light which is received by the first spectrometer 43. Also, the slit plate 451 and the slit moving mechanism 4511 serve as a reflection angle changing part for changing a reflection angle of the reflected light received by the first image pickup element 44.

The rotating phase shifter 41 has a wave retardation plate (λ/4 plate) 411 which is formed of magnesium fluoride (MgF₂), and the wave retardation plate 411 rotates around an axis parallel to the optical axis J1 by a stepping motor 412 which is controlled by the control part 7. Thus, polarized light in accordance with a rotation angle of the stepping motor 412 is led out from the wave retardation plate 411 to enter the analyzer 42. In the present preferred embodiment, a Glan-Taylor prism is used as the analyzer 42.

The light incident on the analyzer 42 passes through the analyzer 42 to be received by the first spectrometer 43. The first spectrometer 43 is preferably a Czerny-Turner spectrometer having a back-illuminated one-dimensional CCD (Charge Coupled Device) which is cooled by a Peltier device or the like, and the first spectrometer 43 disperses incident light with high wavelength resolution to measure the intensity of light at each wavelength (e.g., each wavelength from ultraviolet ray to near-infrared ray) with high sensitivity. Then, the intensity of reflected light at each wavelength is associated with the rotation angle of the rotating phase shifter 41, to acquire a polarization state of the reflected light at each wavelength, specifically, a phase difference between a p-polarized component and an s-polarized component at each wavelength and an angle whose tangent gives an amplitude ratio of these reflected polarized components (i.e., a complex amplitude ratio) and reflectances of a p-polarized component and an s-polarized component (i.e., a ratio of the intensity of the reflected light relative to the intensity of the light which enters the substrate 9 from the first lighting part 3).

In the first lighting part 3, light emitted from the first light source 31b is reflected on a front surface of the pinhole mirror 354 through a lens 357 and directed to the polarizer 32 through the plane mirror 355 and the ellipsoidal mirror 356. Polarized light which is led out by the polarizer 32 enters the upper surface of the substrate 9 at an incident angle of 70 degrees to be applied to an inspection region which includes the inspection region irradiated with the light from the first light source 31a and is larger than the inspection region.

Reflected light reflected on the substrate 9 is led to the analyzer 42 through the slit plate 451, a lens 452 and the rotating phase shifter 41 of the first light receiving part 4, and light incident on the analyzer 42 enters a first wavelength changing part 46 through the analyzer 42 and the lens 453. The first wavelength changing part 46 has a disk-shaped filter wheel 461 for holding a plurality of optical filters (e.g., interference filters with a half band width of 10 nm (nanometer)) each of which transmits light with one of a plurality of wavelengths different from one another (actually, the light is one with a narrow wavelength band) and a filter rotating motor 462 which is attached to the central portion of the filter wheel 461 to rotate the filter wheel 461. The filter wheel 461 is positioned so that its normal direction is parallel to the optical path from the analyzer 42 to the first image pickup element 44.

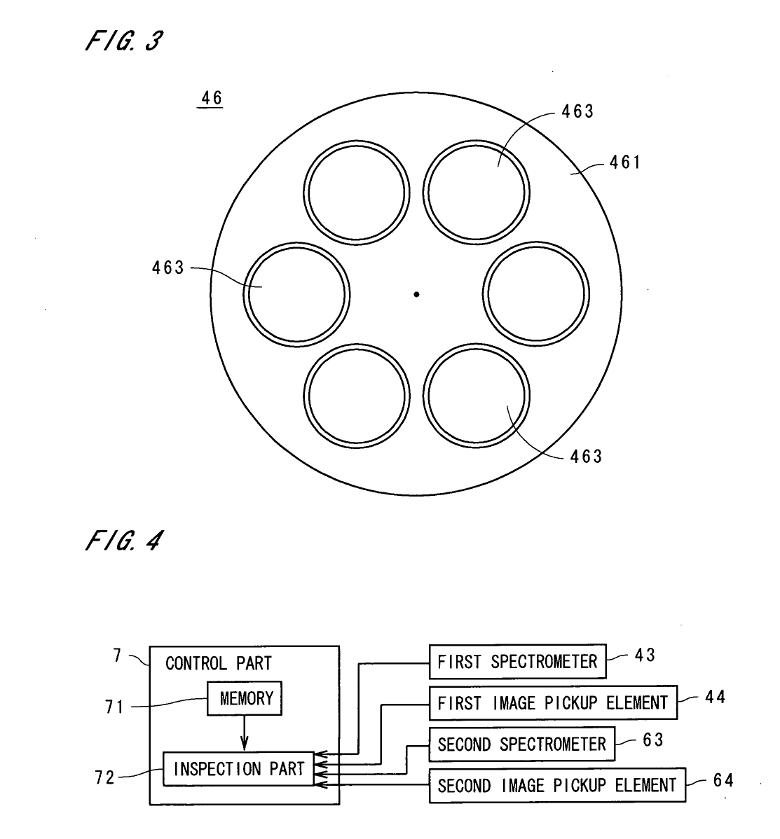

FIG. 3 is a view showing the first wavelength changing part 46 which is viewed from the analyzer 42 shown in FIG. 1 along a direction perpendicular to the filter wheel 461. As shown in FIG. 3, the filter wheel 461 has six types of optical filters 463 having different transmission wavelengths, the optical filters 463 being arranged in a circumferential direction at a pitch. In the first wavelength changing part 46 shown in FIG. 1, the filter wheel 461 rotates by the filter rotating motor 462 and one of the optical filters 463 (see FIG. 3) which corresponds to a type of defects to be detected is positioned on the optical path from the analyzer 42 to the first image pickup element 44. With this operation, the optical filter 463 positioned on the optical path limits a wavelength of the reflected light of the white light reflected on the substrate 9 to a specific wavelength, and (only) light with the specific wavelength passes though the above optical filter 463 to be directed to the first image pickup element 44.

When the filter wheel 461 rotates by the filter rotating motor 462 in the first wavelength changing part 46, the optical filter 463 positioned on the optical path out of the plurality of optical filters 463 is exchanged to another optical filter 463 to change a wavelength of light received by the first image pickup element 44. In the first wavelength changing part 46, the filter rotating motor 462 serves as a filter exchanging mechanism for exchanging an optical filter 463 which is positioned on the optical path out of the plurality of optical filters 463 to another optical filter 463.

In the first image pickup element 44 shown in FIG. 1, the intensity of the light with the specific wavelength which passing through the first wavelength changing part 46 is measured and the intensity of the reflected light is associated with the rotation angle of the rotating phase shifter 41, to thereby acquire a polarization state of the reflected light with the specific wavelength. In the first image pickup element 44, acquired is a polarization state of an inspection region on the substrate 9 which includes the inspection region where the polarization state is acquired by the first spectrometer 43 and is larger than the inspection region. In a case where the reflected light is received by the first image pickup element 44, the number or types of lenses which are located on the optical path in the first light receiving part 4 may be changed from the case where the reflected light is received by the first spectrometer 43, as necessary (the same as in the second light receiving part 6).

In the first light receiving part 4 of the defect inspection apparatus 1, it is preferable that the defect inspection is performed on the basis of output from the first spectrometer 43 where the inspection region is relatively small, in a case where inspection on a small region on the substrate 9, e.g., inspection of a test pattern formed on the substrate 9, is performed. On the other hand, it is preferable that the defect inspection is performed on the basis of output from the first image pickup element 44 where the inspection region is relatively large, in a case where inspection on a large region on the substrate 9, e.g., inspection of an actual pattern formed on the whole substrate 9, is performed (the same as in the second light receiving part 6).

In the second lighting part 5, light emitted from the second light source 51 is reflected on a half mirror 551 and enters the upper surface of the substrate 9 through the objective lens 552 so as to be perpendicular to the upper surface and applied to the substrate 9. In the present preferred embodiment, a numerical aperture of the objective lens 552 is made to be equal to or smaller than 0.1. Reflected light reflected on the substrate 9 is directed to a pinhole mirror 654 through the objective lens 552, the half mirror 551 and a lens 653, and the reflected light passing through an aperture part of the pinhole mirror 654 is received by the second spectrometer 63. In the second spectrometer 63, the intensity at each wavelength of the reflected light reflected on the substrate 9 is measured with high sensitivity and a reflectance at each wavelength is acquired as a reflection property of the reflected light. The second spectrometer 63 is preferably a Czerny-Turner spectrometer similarly to the first spectrometer 43.

A part of the reflected light which is directed to the pinhole mirror 654 is reflected on the pinhole mirror 654 and is incident on a second wavelength changing part 66 through a lens 655. Similarly to the first wavelength changing part 46, the second wavelength changing part 66 has a disk-shaped filter wheel 661 for holding a plurality of optical filters each of which transmits light with one of a plurality of wavelengths different from one another (actually, the light is one with a narrow wavelength band) and a filter rotating motor 662 which is attached to the central portion of the filter wheel 661 to rotate the filter wheel 661.

Also in the second wavelength changing part 66, similarly to the first wavelength changing part 46, one of the optical filters which corresponds to a type of defects to be detected is positioned on the optical path from the pinhole mirror 654 to the second image pickup element 64. With this operation, the optical filter positioned on the optical path limits a wavelength of the reflected light of the white light reflected on the substrate 9 to a specific wavelength, and (only) light with the specific wavelength passes though the above optical filter to be directed to the second image pickup element 64.

In the second image pickup element 64, the intensity of the light with the specific wavelength which passing through the second wavelength changing part 66 is measured to acquire a reflectance which represents a reflection property of the reflected light with the specific wavelength. In the second image pickup element 64, acquired is a polarization state of an inspection region on the substrate 9 which includes the inspection region where the polarization state is acquired by the second spectrometer 63 and is larger than the inspection region.

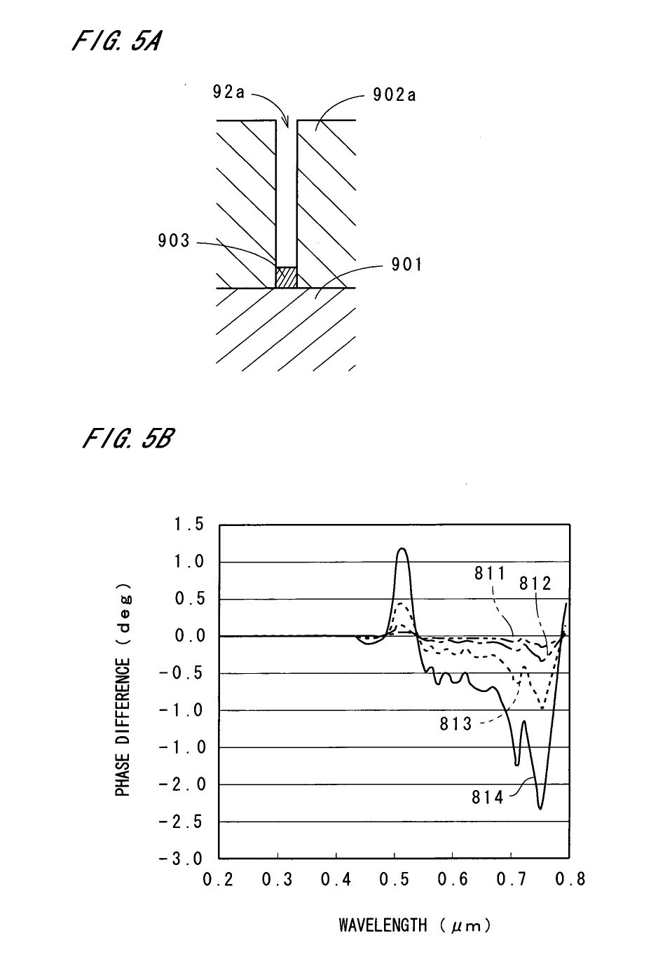

Next discussion will be made on details of the control part 7. FIG. 4 is a block diagram showing functions implemented by the control part 7, together with the other constituent elements in the defect inspection apparatus 1. As shown in FIG. 4, the control part 7 has a memory 71 and an inspection part 72. A plurality of wavelengths of light (hereinafter, referred to as “inspection wavelengths”) used for defect inspection and a plurality of reflection angles (hereinafter, referred to as “inspection reflection angles”) on the substrate 9 of light used for defect inspection are stored in the memory 71 in advance. A plurality of threshold values for determining the presence or absence of defects are also stored in the memory 71 in advance. The plurality of inspection wavelengths, the plurality of inspection reflection angles, and the plurality of threshold values correspond to a plurality of types of defects which are to be detected in the defect inspection apparatus 1, respectively. In the inspection part 72, a group of defects in a plurality of recessed portions formed in the inspection region on the substrate 9 is detected on the basis of the threshold values stored in the memory 71 and the reflection properties of the reflected light which are outputted from the first spectrometer 43, the first image pickup element 44, the second spectrometer 63, or the second image pickup element 64.

In the defect inspection apparatus 1, the plurality of inspection wavelengths, the plurality of inspection reflection angles, and the plurality of threshold values stored in the memory 71 are determined on the basis of theoretical calculation such as RCWA (Rigorous Coupled Wave Analysis) or FDTD (Finite Difference Time Domain). The RCWA is one of electromagnetic field analyses and is a technique where an object is divided into a plurality of layers in a depth direction and analysis is performed on the basis of a dielectric constant distribution of each layer. The FDTD is also one of electromagnetic field analyses and is a technique where Maxwell's equations are directly expanded to differential equations in space and time domain and the differential equations are sequentially calculated to determine electric field and magnetic field.

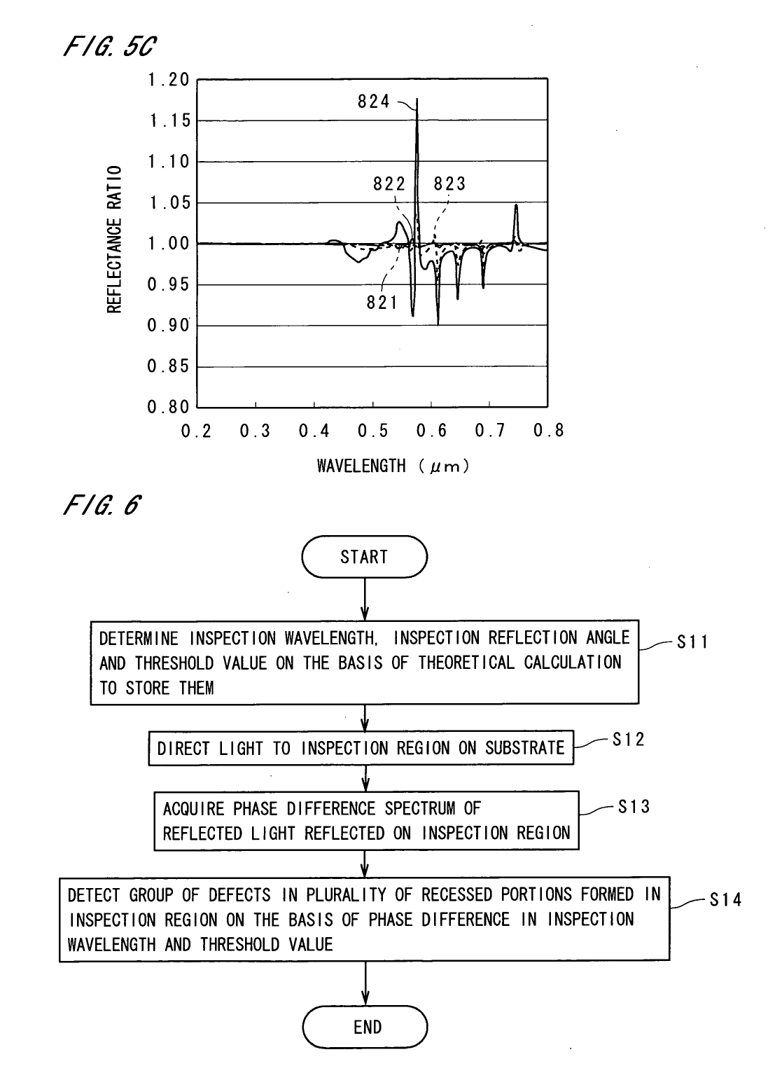

Next, discussion will be made on a technique for determining the inspection wavelength, the inspection reflection angle and the threshold value by the theoretical calculation. The following discussion is made on determination of an inspection wavelength and a threshold value corresponding to the defects shown in FIG. 2A (i.e., abnormality in depth of the recessed portions). FIG. 5A is an enlarged cross sectional view showing the vicinity of a recessed portion 92a having the defect in FIG. 2A. An oxide film 902a with a thickness of 700 nm is formed on the substrate main body 901 of the substrate 9 shown in FIG. 5A and a residue 903 caused by impurities adheres on the bottom part of the recessed portion 92a (so-called hole) which is formed in the oxide film 902a, having a diameter of 65 nm. Air exists above the residue 903 in the recessed portion 92a. The diameter (width) of the recessed portion 92a is smaller than later-discussed inspection wavelengths (0.5 μm, 0.58 μm, 0.63 μm, 0.755 μm).

FIG. 5B is a graph showing results where a phase difference between a p-polarized component and an s-polarized component of reflected light (whose reflection angle is 70 degrees) in a case that polarized light is applied to the recessed portion 92a at an incident angle of 70 degrees, is obtained by the RCWA. The horizontal axis and the vertical axis in FIG. 5B represent a wavelength of incident light and a phase difference between a p-polarized component and an s-polarized component of reflected light, respectively. Lines 811 to 814 in FIG. 5B represent a phase difference spectrum in a case that the height of the residue 903 is 10 nm, 20 nm, 50 nm, or 100 nm.

As shown in FIG. 5B, in the theoretical calculation, the wavelength where change of signal by change of the height of the residue 903 is larger is 0.5 μm and 0.755 μm and as the height of the residue 903 is higher (i.e., the amount of the residue 903 is increased), the phase difference in the wavelength 0.5 μm becomes larger on the plus side and the phase difference in the wavelength 0.755 μm becomes larger on the minus side. Therefore, the inspection reflection angle corresponding to the defects with abnormality of depth shown in FIG. 5A is determined to 70 degrees, the inspection wavelength is determined to 0.5 μm and 0.755 μm, and then the inspection reflection angle and the inspection wavelengths are stored in the memory 71 (see FIG. 4) of the control part 7.

A substrate where the height of the residue 903 is smaller than 20 nm is treated as a non-defective substrate (i.e., the height of the residue 903 is in a range of process margin) and a substrate where the height of the residue 903 is equal to or larger than 20 nm is treated as a defective substrate having defects. A difference between a phase difference at the inspection wavelength 0.5 μm in a border between the non-defective substrate and the defective substrate and a phase difference at the inspection wavelength 0.755 μm in the border is obtained from FIG. 5B, and 0.5 degrees which is the above difference between the phase differences is stored in the memory 71 as a threshold value. The process margin described here is an index which represents a degree of margin of process in a manufacturing line of a semiconductor device and even if there are variations in quality of a semiconductor device caused by variations in process property, the process margin is set so that the quality of the semiconductor device falls in a range of the non-defective substrate.

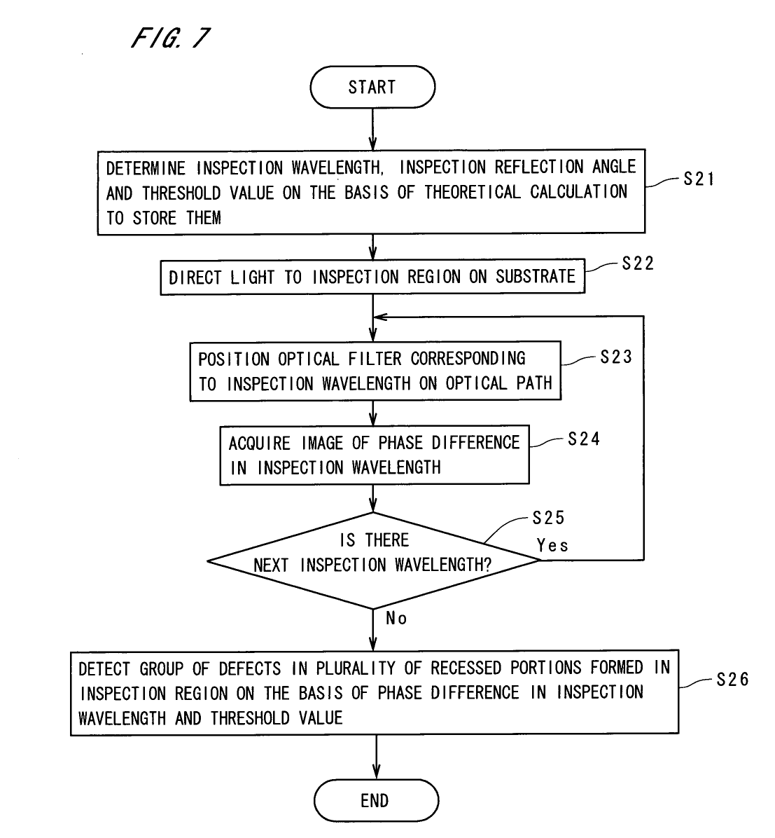

Next discussion will be made on inspection of the defects with abnormality of depth shown in FIG. 5A in the defect inspection apparatus 1. FIG. 6 is a flowchart showing a flow of defect inspection in the defect inspection apparatus 1. In the defect inspection apparatus 1 shown in FIG. 1, first, the inspection wavelength, the inspection reflection angle and the threshold value which are used for defect inspection are determined on the basis of the theoretical calculation (the RCWA in the present preferred embodiment) in accordance with a type of defects to be detected and stored in the memory 71 (see FIG. 4) of the control part 7, as discussed above (Step S11).

Subsequently, light irradiation by the first light source 31a in the first lighting part 3 is started and light emitted from the first light source 31a is directed to an inspection region on the upper surface of the substrate 9 while being polarized by the polarizer 32 (Step S12). Reflected light of the polarized light directed to the inspection region is received by the first spectrometer 43 in the first light receiving part 4, and a phase difference spectrum representing the reflection property of the reflected light (i.e., a phase difference at each wavelength) is acquired by the first spectrometer 43 and transmitted to the inspection part 72 (see FIG. 4) of the control part 7 (Step S13). In the first light receiving part 4, a position of the slit plate 451 is adjusted by the slit plate moving mechanism 4511 in advance so that a reflection angle on the substrate 9 of the reflected light received by the first spectrometer 43 becomes 70 degrees which is the inspection reflection angle stored in the memory 71 in advance.

In the inspection part 72, a difference between the phase difference in 0.5 μm and the phase difference in 0.755 μm, both inspection wavelengths being stored in the memory 71 in advance, is obtained from the phase difference spectrum which is outputted from the first spectrometer 43 and the above difference is compared with the threshold value (0.5 degrees) stored in the memory 71 in advance. In a case where the above difference between the phase differences is larger than the threshold value, it is determined that the defect with abnormality of depth exists in each of the plurality of recessed portions formed in the inspection region on the substrate 9. In other words, a group of defects with abnormality of depth in the plurality of recessed portions 92 formed in the inspection region on the substrate 9 is detected on the basis of the reflection property in the inspection wavelength acquired by the first spectrometer 43 and the threshold value stored in the memory 71 in advance (Step S14).

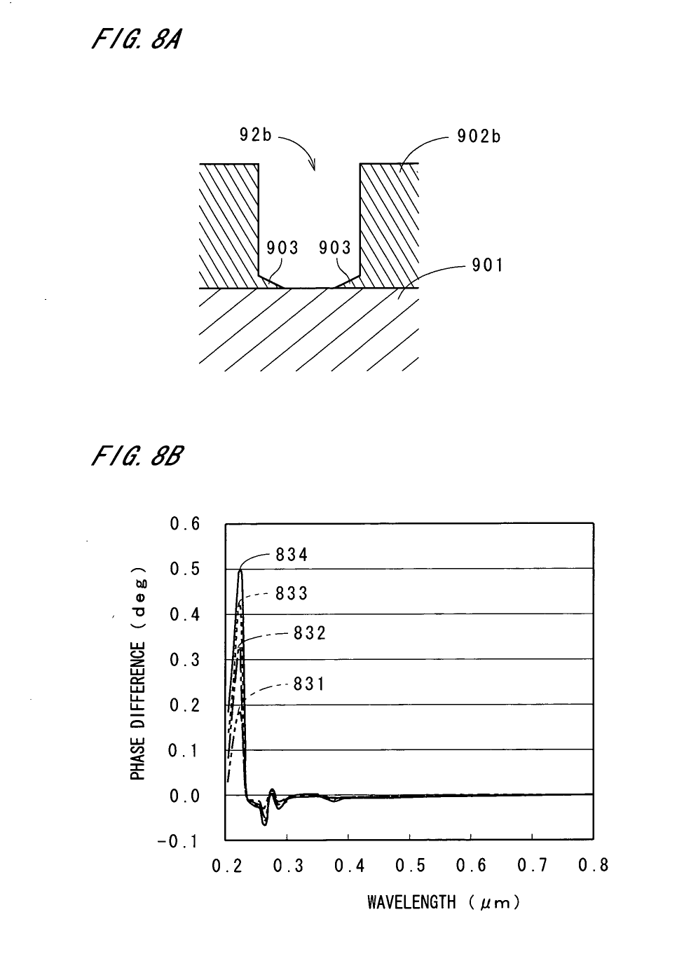

In the defect inspection apparatus 1, defect inspection may be performed by using the first image pickup element 44 as a sensor in the first light receiving part 4, instead of the first spectrometer 43. FIG. 7 is a flowchart showing a flow of defect inspection which is performed with use of the first image pickup element 44. In this case, defect inspection is performed on an inspection region which is larger than the inspection region in the above-discussed defect inspection performed with use of the first spectrometer 43.

In the defect inspection apparatus 1, similarly to the above-discussed case, the inspection wavelength, the inspection reflection angle and the threshold value which are used for defect inspection are determined on the basis of the theoretical calculation in accordance with a type of defects and stored in the memory 71 (Step S21). Subsequently, light irradiation by the first light source 31b in the first lighting part 3 is started and light emitted from the first light source 31b is directed to the inspection region on the upper surface of the substrate 9 while being polarized by the polarizer 32 (Step S22).

In the first wavelength changing part 46 in the first light receiving part 4, the filter rotating motor 462 is controlled by the control part 7 to rotate the filter wheel 461 and an optical filter 463 (see FIG. 3) which corresponds to the inspection wavelength 0.5 μm stored in the memory 71 in advance (i.e., an optical filter 463 passing through light of 0.5 μm which is the inspection wavelength) is positioned on the optical path (Step S23). Also, a position of the slit plate 451 is adjusted by the slit plate moving mechanism 4511 so that a reflection angle on the substrate 9 of the reflected light received by the first image pickup element 44 becomes 70 degrees which is the inspection reflection angle stored in the memory 71 in advance.

The reflected light of the polarized light directed to the inspection region is received by the first image pickup element 44 through the optical filter 463 and an image of the phase difference in the inspection wavelength 0.5 μm which represents the reflection property of the reflected light is acquired by the first image pickup element 44 and transmitted to the inspection part 72 of the control part 7 (Step S24). In the control part 7, it is checked if there is the next inspection wavelength (Step S25) and when the next inspection wavelength is stored in the memory 71, the operation is returned back to Step S23 and another optical filter 463 corresponding to the inspection wavelength 0.755 μm is positioned on the optical path by the filter rotating motor 462 (Step S23). An image of the phase difference in the inspection wavelength 0.755 μm representing the reflection property of the reflected light is acquired by the first image pickup element 44 and transmitted to the inspection part 72 (Step S24).

When it is confirmed there is not the next inspection wavelength (Step S25), a difference of the phase differences in the two inspection wavelengths in each of a plurality of pixels in the phase difference images in the two inspection wavelengths which are outputted from the first image pickup element 44 is obtained in the inspection part 72 on the basis of the above phase difference images (i.e., polarizing properties representing the reflection properties in the inspection wavelengths). Then, a difference of the phase differences in each pixel is compared with the threshold value (0.5 degrees) stored in the memory 71 in advance and a group of defects with abnormality of depth in the plurality of recessed portions 92 which are formed in a region on the inspection region on the substrate 9, the region corresponding to each pixel, is detected (Step S26).

In the defect inspection apparatus 1, defect inspection may be performed by using the second lighting part 5 and the second light receiving part 6, instead of the first lighting part 3 and the first light receiving part 4. FIG. 5C is a graph showing results where a reflectance in a case that light is applied to the recessed portion 92a having the defect shown in FIG. 5A (i.e., abnormality in depth) so as to be perpendicular to the recessed portion 92a (the reflection angle is 0 degree), is obtained by the RCWA. The horizontal axis in FIG. 5C represents a wavelength of incident light and the vertical axis represents a reflectance ratio which is a ratio of a reflectance in the vicinity of the recessed portion 92a, relative to a reflectance in the case that no defect exists in the recessed portion. Lines 821 to 824 in FIG. 5C represent a reflectance ratio spectrum in a case that the height of the residue 903 is 10 nm, 20 nm, 50 nm, or 100 nm.

As shown in FIG. 5C, in the theoretical calculation, the wavelength where change of signal by change of the height of the residue 903 is larger is 0.58 μm and 0.63 μm and as the height of the residue 903 is higher, the reflectance ratio in the wavelength 0.58 μm becomes larger and the reflectance ratio in the wavelength 0.63 μm becomes smaller. Therefore, the inspection reflection angle corresponding to the defects with abnormality of depth shown in FIG. 5A is determined to 0 degrees, the inspection wavelength is determined to 0.58 μm and 0.63 μm, and then the inspection reflection angle and the inspection wavelengths are stored in the memory 71 (see FIG. 4) of the control part 7. Further, a substrate where the height of the residue 903 is equal to or larger than 20 nm is treated as a defective substrate, a difference between a reflectance ratio in the wavelength 0.58 μm in this case and a reflectance ratio in the wavelength 0.63 μm in this case is obtained from FIG. 5C, and 2% which is the above difference between the reflectance ratios is stored in the memory 71 as a threshold value.

The flow of defect inspection using the second lighting part 5 and the second light receiving part 6 is almost same as in FIG. 6 in the case that the second spectrometer 63 is used in the second lighting part 6, and is different in that the light emitted from the second light source 51 is directed to the inspection region on the substrate 9 without being polarized in Step S12 and the difference between the reflectance ratios in the two inspection wavelengths is obtained from the reflectance ratio spectrum acquired by the second spectrometer 63 to be compared with the threshold value in Steps S13, S14.

The flow of defect inspection in the case the second image pickup element 64 is used in the second light receiving part 6 is almost same as in FIG. 7, and is different in that the light emitted from the second light source 51 is directed to the inspection region on the substrate 9 without being polarized in Step S22 and the reflectance ratios in the two inspection wavelengths are acquired by the second image pickup element 64 and the difference between the reflectance ratios is compared with the threshold value in Steps S24, S26.

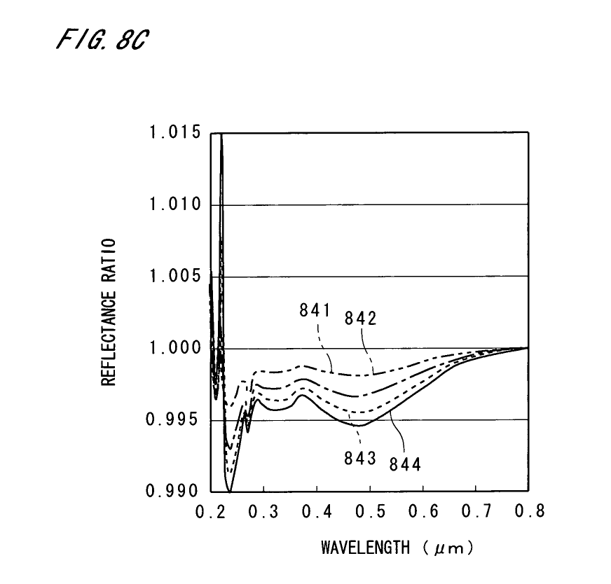

Next, discussion will be made on inspection of the defects shown in FIG. 2B (i.e., abnormality in width of the recessed portions) in the defect inspection apparatus 1. FIG. 8A is an enlarged cross sectional view showing the vicinity of a recessed portion 92b having the defect in FIG. 2B. A resist film 902b with a thickness of 100 nm is formed on the substrate main body 901 of the substrate 9 shown in FIG. 8A, and residues 903 of resist adhere on side wall portions of the groove-like recessed portion 92b in the vicinity of the bottom part of the recessed portion 92b, the recessed portion 92b being formed in the resist film 902b and having a width of 80 nm. Each height of the residues 903 adhering on the side wall portions is 10 nm. Air exists above the residues 903 in the recessed portion 92b. The width of the recessed portion 92b is smaller than later-discussed inspection wavelengths (0.22 μm, 0.225 μm, 0.24 μm).

FIG. 8B is a graph showing results where a phase difference spectrum between a p-polarized component and an s-polarized component of reflected light (whose reflection angle is 70 degrees) in a case that polarized light is applied to the recessed portion 92b at an incident angle of 70 degrees, is obtained by the RCWA. The horizontal axis and the vertical axis in FIG. 8B represent a wavelength of incident light and a phase difference between a p-polarized component and an s-polarized component of reflected light, respectively. Lines 831 to 834 in FIG. 8B represent a phase difference spectrum in a case that the total width of the residues 903 on the bottom surface of the recessed portion 92b (i.e., the sum of widths on the bottom surface of the residues 903 adhering on the both side wall portions) is 20 nm, 40 nm, 60 nm, or 80 nm.

As shown in FIG. 8B, in the theoretical calculation, the wavelength where change of signal by change of the total width of the residues 903 is larger is 0.225 μm and as the total width of the residues 903 is increased (i.e., the amount of the residues 903 is increased), the phase difference in the wavelength 0.225 μm becomes larger on the plus side. Change of signal by change of the total width of the residues 903 is small in another wavelength. Therefore, the inspection reflection angle corresponding to the defects with abnormality of width shown in FIG. 8A is determined to 70 degrees, the inspection wavelength is determined to 0.225 μm, and then the inspection reflection angle and the inspection wavelength are stored in the memory 71 (see FIG. 4) of the control part 7. Further, a substrate where the total width of the residues 903 is equal to or larger than 20 nm is treated as a defective substrate, a phase difference in the wavelength 0.225 μm in this case is obtained from FIG. 8B, and 0.18% which is the above phase difference is stored in the memory 71 as a threshold value.

The flow of defect inspection of abnormality in width in the defect inspection apparatus 1 is the same as in FIG. 6 in the case that the first spectrometer 43 in the first light receiving part 4 is used as a sensor, and is the same as in FIG. 7 in the case that the first image pickup element 44 is used as a sensor. In the defect inspection apparatus 1, detection of abnormality in width caused by excessive etching shown in FIG. 2C is performed similarly to detection of abnormality in width caused by the above-discussed adhesion of resist.

In the defect inspection apparatus 1, there may be a case where phase differences in the plurality of inspection wavelengths (i.e., the inspection wavelengths (0.5 μm, 0.755 μm) for defect detection of abnormality in depth and the inspection wavelengths (0.58 μm, 0.63 μm) for defect detection of abnormality in width which are stored in the memory 71 in advance) are obtained in the inspection part 72 (see FIG. 4) of the control part 7 on the basis of the plurality of inspection wavelengths and the phase difference spectrums (i.e., the phase differences at respective wavelengths) which are acquired by the first spectrometer 43, and the presence or absence of each group of the defects with abnormality of depth and the defects with abnormality of width (i.e., the presence or absence of each group of the plurality of types of defects) are sequentially (or concurrently) inspected on the basis of the above plurality of phase differences and the threshold values which are stored in the memory 71 in advance, correspondingly to the defects with abnormality of depth and the defects with abnormality of width, respectively.

In the defect inspection apparatus 1, there may be a case where a plurality of phase difference images corresponding to the plurality of inspection wavelengths used for defect detection of abnormality in depth and defect detection of abnormality in width are acquired by the first image pickup element 44, and the presence or absence of each group of the defects with abnormality of depth and the defects with abnormality of width (i.e., the presence or absence of each group of the plurality of types of defects) are inspected on the basis of the plurality of inspection wavelengths and the plurality of threshold values which are stored in the memory 71 in advance and the plurality of phase difference images outputted from the first image pickup element 44 (a plurality of reflection properties which correspond to the plurality of inspection wavelengths, respectively).

Similarly to the above case of defect detection of abnormality in depth, defect inspection of abnormality in width may be performed in the defect inspection apparatus 1 by using the second lighting part 5 and the second light receiving part 6, instead of the first lighting part 3 and the first light receiving part 4. FIG. 8C is a graph showing results where a reflectance in a case that light is applied to the recessed portion 92b having the defect shown in FIG. 8A (i.e., abnormality in width) so as to be perpendicular to the recessed portion 92b (the reflection angle is 0 degree), is obtained by the RCWA. The horizontal axis in FIG. 8C represents a wavelength of incident light and the vertical axis represents a reflectance ratio which is a ratio of a reflectance in the vicinity of the recessed portion 92b, relative to a reflectance in the case that no defect exists in the recessed portion. Lines 841 to 844 in FIG. 8C represent a reflectance ratio spectrum in a case that the total width of the residues 903 on the bottom surface of the recessed portion 92b is 20 nm, 40 nm, 60 nm, or 80 nm.

As shown in FIG. 8C, in the theoretical calculation, the wavelength where change of signal by change of the total width of the residues 903 is larger is 0.22 μm and 0.24 μm and as the total width of the residues 903 is increased, the reflectance ratio in the wavelength 0.22 μm becomes larger and the reflectance ratio in the wavelength 0.24 μm becomes smaller. Therefore, the inspection reflection angle corresponding to the defects with abnormality of width shown in FIG. 8A is determined to 0 degrees (i.e., vertical light), the inspection wavelength is determined to 0.22 μm and 0.24 μm, and then the inspection reflection angle and the inspection wavelengths are stored in the memory 71 (see FIG. 4) of the control part 7. Further, a substrate where the total width of the residues 903 is equal to or larger than 20 nm is treated as a defective substrate, a difference between a reflectance ratio in the wavelength 0.22 μm in this case and a reflectance ratio in the wavelength 0.24 μm in this case is obtained from FIG. 8C, and 1% which is the above difference between the reflectance ratios is stored in the memory 71 as a threshold value.

The flow of defect inspection of abnormality in width using the second lighting part 5 and the second light receiving part 6 is the same as that of defect inspection of abnormality in depth using the second lighting part 5 and the second light receiving part 6. Similarly to defect inspection using the first lighting part 3 and the first light receiving part 4, the presence or absence of each group of the defects with abnormality of depth and the defects with abnormality of width (i.e., the presence or absence of each group of the plurality of types of defects) may be inspected on the basis of a plurality of inspection wavelengths and a plurality of threshold values both of which correspond to the defects with abnormality of depth and the defects with abnormality of width, respectively, and a plurality of reflection properties which are outputted correspondingly to the plurality of inspection wavelengths, respectively.

As discussed above, in the defect inspection apparatus 1, the inspection wavelength and the threshold value which are determined correspondingly to a type of defects to be detected on the basis of the theoretical calculation, are stored in the memory 71 in advance, light is applied to the inspection region on the substrate 9 to acquire the reflection property of the reflected light in the inspection wavelength, the reflected light being reflected on the inspection region, and then a group of defects (e.g., defects with abnormality in depth or abnormality in width in recessed portions) in the plurality of recessed portions 92 formed in the inspection region on the substrate 9 is detected on the basis of the above reflection property and the threshold value stored in the memory 71 in advance. As a result, it is possible to detect a defect in the small recessed portion 92 on the substrate 9 with high accuracy, the defect being difficult to detect in a normal defect inspection apparatus which performs inspection by applying light to a substrate. The defect inspection apparatus 1 is suitable for inspection of a defect in a small recessed portion whose width is smaller than a wavelength of light used for inspection (i.e., the inspection wavelength).

In the defect inspection apparatus 1, the plurality of inspection wavelengths and the plurality of threshold values both of which correspond to the plurality of types of defects, respectively, are stored in the memory 71 in advance and the presence or absence of each group of the plurality of types of defects are inspected on the basis of the plurality of threshold values and the reflection properties of reflected light which correspond to the plurality of inspection wavelengths, respectively, and it is therefore possible to detect each of the plurality of types of defects in the recessed portions with high accuracy.

In the defect inspection apparatus 1, since the slit plate 451 and the slit plate moving mechanism 4511 in the first light receiving part 4 change the reflection angle on the substrate 9 of the reflected light received by the first spectrometer 43 and the first image pickup element 44, to the inspection reflection angle where change of signal is larger depending on the presence or absence of defects or a size of a defect, it is possible to detect a defect in the recessed portion 92 more accurately. Since the defect inspection apparatus 1 has the first lighting part 3 and the first light receiving part 4 and the second lighting part 5 and the second light receiving part 6, it is possible to change the reflection angle of the reflected light to various angles including 0 degrees and to detect a defect in the recessed portion 92 with higher accuracy.

In the first light receiving part 4, the first spectrometer 43 receives the reflected light of the white light emitted from the first light source 31a to acquire the reflection property at each wavelength, to thereby easily acquire the reflection property in the inspection wavelength and further, to rapidly acquire the reflection property in each of the plurality of inspection wavelengths at one light receiving.

The wavelength of the reflected light received by the first image pickup element 44 is changed by the first wavelength changing part 46 and the reflection property in the inspection wavelength can be easily acquired also in the first image pickup element 44. Further, since the optical filter 463 is positioned on the optical path in the first wavelength changing part 46, light with the inspection wavelength is selectively taken out from the white light emitted from the first light source 31b and it is possible to more easily perform change of wavelength of the reflected light received by the first image pickup element 44.

In the second light receiving part 6, similarly to the first light receiving part 4, the reflected light is received by the second spectrometer 63 and it is therefore possible to easily and rapidly acquire the reflection properties at respective inspection wavelengths at one light receiving. The wavelength of the reflected light is changed by the second wavelength changing part 66 and the reflection property in the inspection wavelength can be easily acquired also in the second image pickup element 64. Further, since the optical filter is used in the second wavelength changing part 66, it is possible to more easily perform change of wavelength of the reflected light received by the second image pickup element 64.

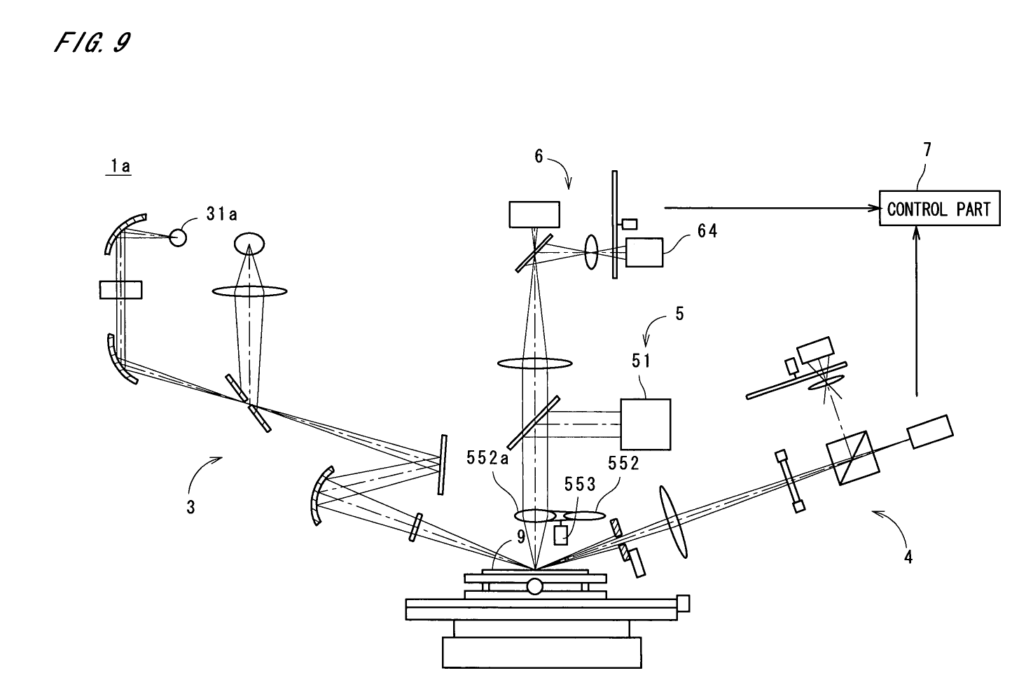

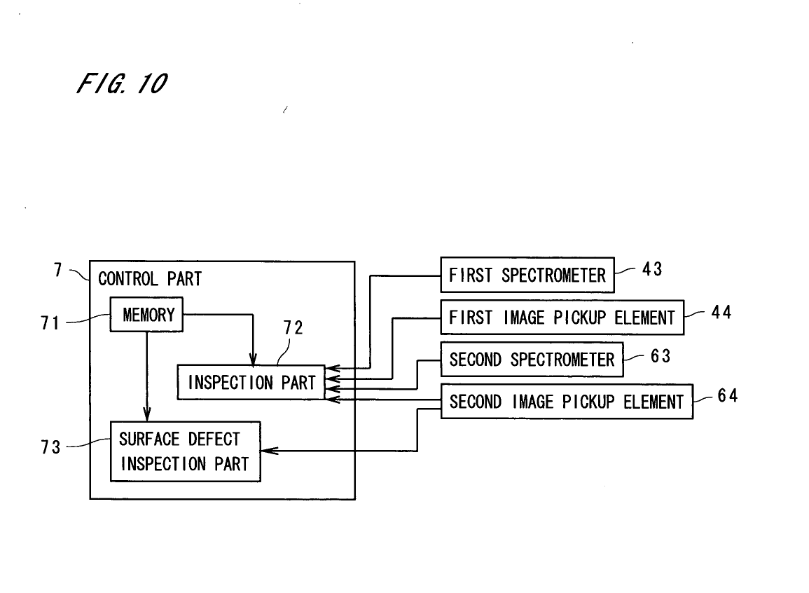

Next discussion will be made on a defect inspection apparatus in accordance with the second preferred embodiment of the present invention. FIG. 9 is a view showing a construction of a defect inspection apparatus 1a in accordance with the second preferred embodiment. As shown in FIG. 9, the defect inspection apparatus 1a is provided with an objective lens exchanging mechanism 553 which exchanges the objective lens 552 for directing light emitted from the second light source 51 in the second lighting part 5 to the substrate 9, to another objective lens 552a whose magnification and numerical aperture (e.g., 0.8 to 0.9) are greater those of the objective lens 552. In the following description, the objective lens 552 is referred to as a “first objective lens 552” and the objective lens 552a having high magnification is referred to as a “second objective lens 552a” for distinction of the two objective lenses. As shown in FIG. 10, the control part 7 is provided with a surface defect inspection part 73 for detecting a defect on the upper surface of the substrate 9 (for example, the defect is small particles or the like adhering on the upper surface of the substrate 9 and hereinafter, referred to as a “surface defect” for distinction from defects in recessed portions). The other constituent elements are the same as those in the defect inspection apparatus 1 shown in FIG. 1 and represented by the same reference signs in the following description.

In the defect inspection apparatus 1a shown in FIG. 9, the objective lens exchanging mechanism 553 positions the second objective lens 552a on the optical path from the second light source 51 to the substrate 9 and light emitted from the second light source 51 is applied to a small inspection region on the substrate 9 through the second objective lens 552a. The small inspection region where light is applied through the second objective lens 552a is smaller than an inspection region where light is applied through the first objective lens 552 and included in the inspection region. Then, a bright-field image of the small inspection region is acquired by the second image pickup element 64 in the second light receiving part 6 while the light is applied to the small inspection region on the substrate 9, and the surface defect inspection part 73 of the control part 7 detects a surface defect on the small inspection region on the substrate 9 on the basis of the bright-field image.

Also, while light emitted from the first light source 31a is applied to the inspection region on the substrate 9 without performing light emission from the second light source 51 in the defect inspection apparatus 1a, the second image pickup element 64 receives scattered light which is scattered on the small inspection region included in the above inspection region to acquire a dark-field image of the small inspection region. Then, the surface defect inspection part 73 of the control part 7 detects a surface defect on the small inspection region on the substrate 9 on the basis of the dark-field image.

In the defect inspection apparatus 1a, similarly to the defect inspection apparatus 1 according to the first preferred embodiment, the first light receiving part 4 receives the polarized light which is led out from the first lighting part 3 or the second light receiving part 6 receives the reflected light of the light which is applied to the substrate 9 from the second light source 51 in the second lighting part 5 through the objective lens 552, and it is therefore possible to detect a group of defects in a plurality of recessed portions formed in the inspection region on the substrate 9.

In the defect inspection apparatus 1a according to the second preferred embodiment, the second image pickup element 64 in the second light receiving part 6 receives the reflected light of the light which is applied to the small inspection region on the substrate 9 from the second light source 51 through the objective lens 552a to acquire the bright-field image, and it is possible to detect a surface defect on the small inspection region on the substrate 9. Also, the second image pickup element 64 receives scattered light scattered on the small inspection region included in the inspection region to acquire the dark-field image while the polarized light is applied to the inspection region on the substrate 9 from the first light source 31a, and it is possible to detect a surface defect on the small inspection region on the substrate 9.

In the defect inspection apparatus 1a, for example, the inspection region where a group of defects is detected by the first lighting part 3 and the first light receiving part 4, is reinspected on the basis of the bright-field image or the dark-field image which are acquired by the second image pickup element 64, and thereby it is possible to inspect whether or not defects in the plurality of recessed portions are also formed on the upper surface of the substrate 9 (i.e., the upper surface is the surface of the film 902 shown in FIGS. 2A to 2C).

Though the preferred embodiments of the present invention have been discussed above, the present invention is not limited to the above-discussed preferred embodiments, but allows various variations.

Though the defects with abnormality of depth are detected on the basis of the two inspection wavelengths, defects of one type may be detected on the basis of a reflection property of reflected light in one inspection wavelength or reflection properties of reflected light in three or more inspection wavelengths. The reflection properties of reflected light which are used for defect detection and acquired by the first light receiving part 4 and the second light receiving part 6 are not limited to the above-discussed ones (i.e., the phase difference of the polarized light and the reflectance of the vertical light), but may be a polarization state of the reflected light, specifically, a complex amplitude ratio and reflectances of a p-polarized component and an s-polarized component.

In the defect inspection apparatus 1, there may be a case where the first light source 31a and the first spectrometer 43 are omitted from the first lighting part 3 and the first light receiving part 4 and the reflection property of the reflected light is acquired only by the first image pickup element 44. In this case, the first wavelength changing part 46 is not necessarily positioned between the analyzer 42 and the first image pickup element 44, as long as the first wavelength changing part 46 is positioned on the optical path from the first light source 31b to the first image pickup element 44. In a case where the second spectrometer 63 is not provided in the second light receiving part 6 and the reflection property of the reflected light is acquired only by the second image pickup element 64, the second wavelength changing part 66 is not necessarily positioned between the pinhole mirror 654 and the second image pickup element 64, as long as the second wavelength changing part 66 is positioned on the optical path from the second light source 51 to the second image pickup element 64.

In the defect inspection apparatus 1, the slit plate 451 and the slit moving mechanism 4511 in the first light receiving part 4 serve as the reflection angle changing part for changing the reflection angle on the substrate 9 of the reflected light which is received by the first spectrometer 43 or the first image pickup element 44, but for example, the first lighting part 3 is provided with a mechanism for changing the incident angle on the substrate 9 of the light emitted from the first light source 31a or 31b by mechanically changing an orientation of the first light source 31a or 31b (i.e., an outgoing direction of the light) and the above mechanism may be used as the reflection angle changing part.

The first light sources 31a, 31b in the first lighting part 3 are not limited to the xenon lamp but may be other types of lamps. The light emitted from the first light sources 31a, 31b is not limited to the white light, but for example, there may be a case where a plurality of LEDs having different wavelengths are provided as the first light source 31a and an LED emitting light is exchanged by an LED control part for controlling the LEDs, to thereby change a wavelength of reflected light received by the first light receiving part 4. In this case, the first wavelength changing part 46 having the plurality of optical filters 463 is omitted and the LED control part functions as a wavelength changing part for changing a wavelength of the reflected light to the inspection wavelength (the same as in the second lighting part 5).

The first lighting part 3 and the first light receiving part 4 or the second lighting part 5 and the second light receiving part 6 may be omitted in the defect inspection apparatus 1. In the case that the second lighting part 5 and the second light receiving part 6 are omitted and defect inspection is performed by the first lighting part 3 and the first light receiving part 4, the construction of the apparatus is simplified and the reflection angle on the substrate 9 of the reflected light can be easily changed by the reflection angle changing part (i.e., the slit plate 451 and the slit plate moving mechanism 4511). Conversely, in the case that the first lighting part 3 and the first light receiving part 4 are omitted and defect inspection is performed by the second lighting part 5 and the second light receiving part 6, the construction of the apparatus can be more simplified. Also, in comparison with the defect inspection performed by the first lighting part 3 and the first light receiving part 4, since light is easily incident on the recessed portion in the defect inspection performed by the second lighting part 5 and the second light receiving part 6, the second lighting part 5 and the second light receiving part 6 are more suitable for defect inspection of a recessed portion formed in an opaque film.

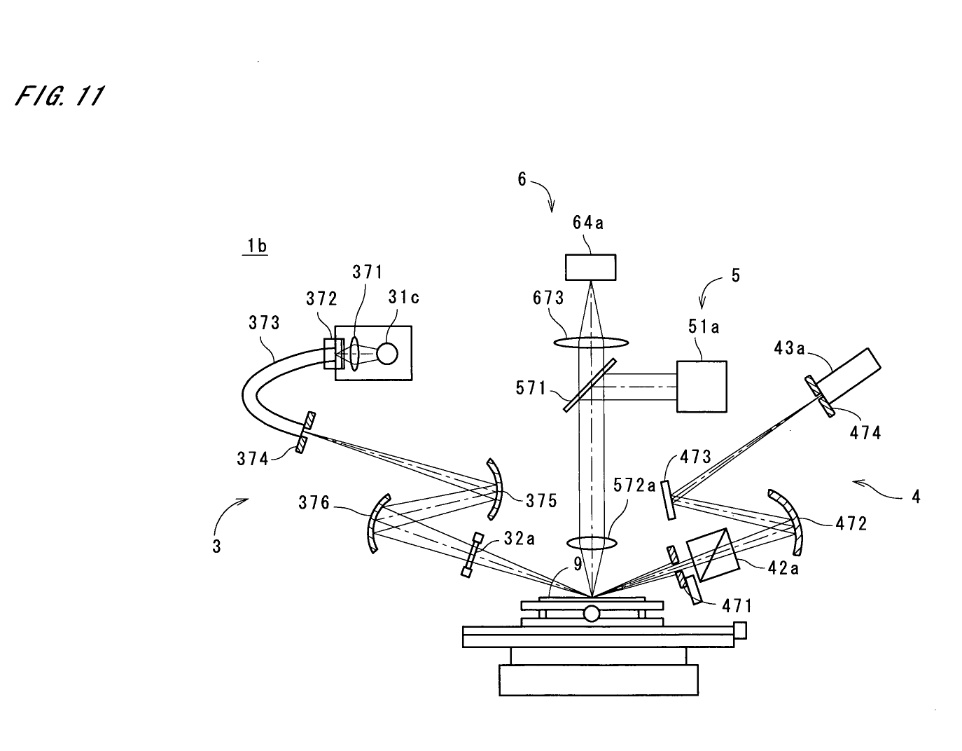

FIG. 11 is a view showing a defect inspection apparatus whose construction is simplified. As shown in FIG. 11, in a defect inspection apparatus 1b, light emitted from a first light source 31c (xenon lamp) in a first lighting part 3 is directed to a slit 374 through a condenser lens 371, a water-cooling unit 372 and optical fibers 373, and the light passing through an aperture part of the slit 374 is directed to a rotating polarizer 32a through ellipsoidal mirrors 375, 376. Polarized light which is led out by the rotating polarizer 32a is incident on an inspection region on the substrate 9 at an incident angle of 70 degrees. Reflected light of the polarized light incident on the inspection region enters an analyzer 42a which is a Rochon prism through a slit 471 in a first light receiving part 4 and the light from the analyzer 42a is received by a spectrometer 43a through a spherical mirror 472, a plane surface mirror 473 and a slit 474.

Light emitted from a second light source 51a in a second lighting part 5 is reflected on a half mirror 571 and enters a small inspection region included in the above inspection region on a substrate 9 through an objective lens 572a having high magnification so as to be perpendicular to the upper surface of the substrate 9 (the objective lens 572a is the same as the objective lens 552a in the defect inspection apparatus 1a according to the second preferred embodiment). Reflected light reflected on the small inspection region is received by an image pickup element 64a through the objective lens 572a, the half mirror 571 and a lens 673.

In the defect inspection apparatus 1b, the reflected light reflected on the substrate 9 of the light from the first light source 31c is received by the spectrometer 43a, and thereby a group of defects in a plurality of recessed portions formed in the inspection region on the substrate 9 can be detected on the basis of a reflection property of the reflected light which is acquired. Also, reflected light reflected on the substrate 9 of the light from the second light source 51a is received by the image pickup element 64a through the objective lens 572a having high magnification to acquire a bright-field image, and thereby a surface defect on the small inspection region can be detected on the basis of the bright-field image. Further, while the second light source 51a is turned off and the light from the first light source 31c is applied to the inspection region on the substrate 9, scattered light scattered on the small inspection region is received by the image pickup element 64a to acquire a dark-field image and it is possible to detect a surface defect on the small inspection region on the basis of the dark-field image.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2007-88409 filed in the Japan Patent Office on Mar. 29, 2007, the entire disclosure of which is incorporated herein by reference.

What is claimed is:

1. A defect inspection apparatus for inspecting defects by applying light to a semiconductor substrate, comprising:
a memory for storing an inspection wavelength which is a wavelength of light used for inspection and a threshold value for determining the presence or absence of defects, said inspection wavelength and said threshold value being determined on the basis of theoretical calculation in accordance with a type of defects which are to be detected;
a substrate holding part for holding a semiconductor substrate;
a lighting part for directing light emitted from a light source to an inspection region on a main surface of said semiconductor substrate;
a light receiving part having a sensor for receiving reflected light reflected on said inspection region on said semiconductor substrate to acquire a reflection property of said reflected light in at least said inspection wavelength; and
an inspection part for detecting a group of defects in a plurality of recessed portions which are formed in said inspection region on said semiconductor substrate, on the basis of said reflection property outputted from said sensor and said threshold value stored in said memory.

2. The defect inspection apparatus according to claim 1, wherein
each width of said plurality of recessed portions is smaller than said inspection wavelength.

3. The defect inspection apparatus according to claim 1, wherein
a type of said group of defects is abnormality in depth or width of recessed portions.

4. The defect inspection apparatus according to claim 1, wherein
said light emitted from said light source enters said main surface of said semiconductor substrate through an objective lens so as to be perpendicular to said main surface, and
said reflection property outputted from said sensor is a ratio of intensity of said reflected light relative to intensity of said light which enters said semiconductor substrate from said lighting part.

5. The defect inspection apparatus according to claim 4, further comprising:
an objective lens exchanging mechanism for exchanging said objective lens to another objective lens whose magnification is greater than that of said objective lens; and
another inspection part for detecting a defect on a small inspection region included in said inspection region on the basis of a bright-field image of said small inspection region, said bright-field image being acquired by said sensor which is an image pickup element through said another objective lens while said light emitted from said light source is applied to said semiconductor substrate.

6. The defect inspection apparatus according to claim 4, wherein
said lighting part or said light receiving part comprises a wavelength changing part for changing a wavelength of said reflected light which is received by said sensor to said inspection wavelength.

7. The defect inspection apparatus according to claim 6, wherein
said wavelength changing part is an optical filter which is positioned on an optical path from said light source emitting white light to said sensor, and
said optical filter limits said wavelength of said reflected light to said inspection wavelength.

8. The defect inspection apparatus according to claim 7, wherein
said memory stores a plurality of inspection wavelengths and a plurality of threshold values both of which correspond to a plurality of types of defects, respectively,
said lighting part or said light receiving part further comprises:
a plurality of optical filters each of which transmits light with one of said plurality of inspection wavelengths; and
a filter exchanging mechanism for exchanging an optical filter which is positioned on said optical path out of said plurality of optical filters to another optical filter, and
said inspection part inspects the presence or absence of each group of said plurality of types of defects on the basis of said plurality of threshold values and a plurality of reflection properties which are outputted from said sensor correspondingly to said plurality of inspection wavelengths, respectively.

9. The defect inspection apparatus according to claim 4, wherein
said light source emits white light, and
said sensor is a spectrometer for acquiring a reflection property at each wavelength of said reflected light.

10. The defect inspection apparatus according to claim 9, wherein
said memory stores a plurality of inspection wavelengths and a plurality of threshold values both of which correspond to a plurality of types of defects, respectively, and
said inspection part inspects the presence or absence of each group of said plurality of types of defects on the basis of reflection properties at respective wavelengths of said reflected light, said plurality of inspection wavelengths, and said plurality of threshold values.

11. The defect inspection apparatus according to claim 1, wherein
said light emitted from said light source is polarized and polarized light enters said main surface of said semiconductor substrate from said lighting part so as to incline to said main surface, and
said reflection property which is outputted from said sensor is a polarization state of said reflected light.

12. The defect inspection apparatus according to claim 11, wherein
said memory stores an inspection reflection angle which is a reflection angle on said semiconductor substrate of light used for inspection, said reflection angle being determined on the basis of theoretical calculation in accordance with a type of defects which are to be detected, and
said lighting part or said light receiving part comprises a reflection angle changing part for changing a reflection angle on said semiconductor substrate of said reflected light which is received by said sensor to said inspection reflection angle.

13. The defect inspection apparatus according to claim 11, further comprising:
an image pickup element for receiving scattered light scattered on a small inspection region included in said inspection region to acquire a dark-field image of said small inspection region while said light emitted from said light source is applied to said semiconductor substrate; and
another inspection part for detecting a defect on said small inspection region on the basis of said dark-field image.

14. The defect inspection apparatus according to claim 13, further comprising
another light source for applying light to said small inspection region through an objective lens, said light being perpendicular to said main surface of said semiconductor substrate, wherein
said image pickup element receives reflected light reflected on said small inspection region through said objective lens to acquire a bright-field image of said small inspection region, and
said another inspection part detects a defect on said small inspection region on the basis of said bright-field image.

15. The defect inspection apparatus according to claim 11, wherein
said lighting part or said light receiving part comprises a wavelength changing part for changing a wavelength of said reflected light which is received by said sensor to said inspection wavelength.

16. The defect inspection apparatus according to claim 15, wherein
said wavelength changing part is an optical filter which is positioned on an optical path from said light source emitting white light to said sensor, and
said optical filter limits said wavelength of said reflected light to said inspection wavelength.

17. The defect inspection apparatus according to claim 16, wherein
said memory stores a plurality of inspection wavelengths and a plurality of threshold values both of which correspond to a plurality of types of defects, respectively,
said lighting part or said light receiving part further comprises:
a plurality of optical filters each of which transmits light with one of said plurality of inspection wavelengths; and
a filter exchanging mechanism for exchanging an optical filter which is positioned on said optical path out of said plurality of optical filters to another optical filter, and
said inspection part inspects the presence or absence of each group of said plurality of types of defects on the basis of said plurality of threshold values and a plurality of reflection properties which are outputted from said sensor correspondingly to said plurality of inspection wavelengths, respectively.

18. The defect inspection apparatus according to claim 11, wherein
said light source emits white light, and
said sensor is a spectrometer for acquiring a reflection property at each wavelength of said reflected light.

19. The defect inspection apparatus according to claim 18, wherein
said memory stores a plurality of inspection wavelengths and a plurality of threshold values both of which correspond to a plurality of types of defects, respectively, and
said inspection part inspects the presence or absence of each group of said plurality of types of defects on the basis of reflection properties at respective wavelengths of said reflected light, said plurality of inspection wavelengths, and said plurality of threshold values.

20. The defect inspection apparatus according to claim 1, wherein
said lighting part or said light receiving part comprises a wavelength changing part for changing a wavelength of said reflected light which is received by said sensor to said inspection wavelength.

21. The defect inspection apparatus according to claim 20, wherein
said wavelength changing part is an optical filter which is positioned on an optical path from said light source emitting white light to said sensor, and
said optical filter limits said wavelength of said reflected light to said inspection wavelength.

22. The defect inspection apparatus according to claim 21, wherein
said memory stores a plurality of inspection wavelengths and a plurality of threshold values both of which correspond to a plurality of types of defects, respectively,
said lighting part or said light receiving part further comprises:
a plurality of optical filters each of which transmits light with one of said plurality of inspection wavelengths; and
a filter exchanging mechanism for exchanging an optical filter which is positioned on said optical path out of said plurality of optical filters to another optical filter, and
said inspection part inspects the presence or absence of each group of said plurality of types of defects on the basis of said plurality of threshold values and a plurality of reflection properties which are outputted from said sensor correspondingly to said plurality of inspection wavelengths, respectively.

23. The defect inspection apparatus according to claim 1, wherein
said light source emits white light, and
said sensor is a spectrometer for acquiring a reflection property at each wavelength of said reflected light.

24. The defect inspection apparatus according to claim 23, wherein
said memory stores a plurality of inspection wavelengths and a plurality of threshold values both of which correspond to a plurality of types of defects, respectively, and
said inspection part inspects the presence or absence of each group of said plurality of types of defects on the basis of reflection properties at respective wavelengths of said reflected light, said plurality of inspection wavelengths, and said plurality of threshold values.

25. A defect inspection method of inspecting defects by applying light to a semiconductor substrate, comprising the steps of:
a) determining an inspection wavelength which is a wavelength of light used for inspection and a threshold value for determining the presence or absence of defects, on the basis of theoretical calculation in accordance with a type of defects which are to be detected;
b) directing light emitted from a light source to an inspection region on a main surface of said semiconductor substrate;
c) receiving reflected light reflected on said inspection region on said semiconductor substrate to acquire a reflection property of said reflected light in at least said inspection wavelength; and
d) detecting a group of defects in a plurality of recessed portions which are formed in said inspection region on said semiconductor substrate, on the basis of said reflection property and said threshold value.
